(19) United States
(12) Patent Application Publication
(10) Pub. No.: US 2026/0180822 A1
(43) Pub. Date: Jun. 25, 2026

(54) NETWORK TUNNELING BETWEEN A MEMORY DEVICE AND AN ELECTRONIC DEVICE

(71) Applicant: SK Hynix NAND Product Solutions Corp. (dba Solidigm), Rancho Cordova, CA (US)

(72) Inventors: Mateusz Piotr NOWICKI, Gliwice (PL); Lukasz PORYCKI, Nowy Dwor Gdanski (PL); Mariusz BARCZAK, Gdansk (PL); Pawel GIERSZEWSKI, Borowiec (PL); Lukasz GIERYK, Gdansk (PL)

(21) Appl. No.: 18/990,809

(22) Filed: Dec. 20, 2024

(51) Int. Cl. H04L 12/40; H04L 12/46

(52) U.S. Cl. CPC H04L 12/40; H04L 12/4633; H04L 2212/00

(57) ABSTRACT

This application is directed to data communication between a memory device and a host device. The memory device includes a data processor, a memory controller, and a non-volatile memory. A communication bus couples the memory device to the host device, and includes a plurality of functions. The communication bus is configured to communicate data based on a data communication protocol. The memory device obtains, from the data processor, first payload data that are generated based on a predefined device protocol. The first payload data is converted to a first outgoing data packet based on the data communication protocol, and the first outgoing data packet is communicated to the host device via a first function of the plurality of functions of the communication bus.

### RELATED APPLICATION

This application is related to U.S. Patent Application No. ______ (Attorney Docket No. 132251-01-5050-US), filed Dec. 20, 2024, titled “Data Communication for Computational Storage Functions of Memory Devices,” which is incorporated by reference in its entirety.

### TECHNICAL FIELD

This application relates generally to data communication in an electronic system including, but not limited to, methods, systems, devices, and non-transitory computer-readable media for exchanging data between a memory device and a host device to facilitate computational storage functions of the memory device.

### BACKGROUND

Memory is employed in an electronic system to store instructions and data. The data are processed by one or more processors of the electronic system according to the instructions stored in the memory. Multiple memory units are used in different portions of the electronic system to serve different functions. Specifically, the electronic system includes non-volatile memory that acts as secondary memory to keep data stored thereon if the electronic system is decoupled from a power source. Examples of the secondary memory include, but are not limited to, hard disk drives (HDDs) and solid-state drives (SSDs). The secondary memory is coupled to, and collaborates with, an external electronic device having one or more processors and specializing in data processing. The secondary memory relies on a memory controller to manage its memory space, and process read, write, and read-modify-write requests from the external electronic device. The secondary memory has been designed to incorporate local in-memory data processing capabilities involving data exchange with a host device. However, it employs a tunneling-based communication scheme that relies on specific vendor commands for data transfer. This approach has been found to be inefficient, ultimately compromising the overall performance of in-memory data processing.

### SUMMARY

Various embodiments of this application are directed to communicating data between computing elements (e.g., a data processor, a host processor) of a memory device and an external electronic device (e.g., a host device). In some embodiments, the memory device is transformed to a computational storage device (CSD) by incorporating at least one computing element (e.g., the data processor). The data processor is configured to process internal computational workloads (e.g., the data processing operations) locally on the memory device, while a memory controller of the memory device specializes in performing memory access functions and internal memory management functions.

In some embodiments, a communication link is established between the data processor of the memory device and the host processor of the host device, allowing data to be communicated between the memory device and the host device in compliance with an interconnect standard (e.g., Peripheral Component Interconnect Express (PCIe or PCI-E)). Further, in some embodiments, the communication link includes a physical communication channel and a virtual communication channel. The physical channel is a physical storage device interface that operates based on a Nonvolatile Memory Express (NVMe) interface standard. The virtual channel is a virtual network device interface based on a VirtIO interface standard. This configuration isolates computation functions, which are based on the virtual network device interface, from storage functions, which are based on the physical storage device interface. In some embodiments, these two channels operate independently, allowing the memory device to focus on the computation functions without interference from the storage functions.

In some embodiments, a paravirtualized interface is applied in an embedded operating system (e.g., Linux) of the data processor of the memory device, and configured to communicate data in compliance with the VirtIO interface standard. The paravirtualized interface is configured to expose the memory device to the host device as a virtual data processing device (e.g., a virtual device) including the data processor. Further, in some embodiments, the paravirtualized interface corresponds to a virtual machine, and is built using VirtIO driver(s) of a standard Linux kernel. By these means, a network tunnel is created between the memory device and the host device for communicating Transmission Control Protocol/Internet Protocol (TCP/IP) data packets, while requiring no custom changes to network drivers and/or NVMe commands.

In one aspect of the application, a method is implemented for data communication at a memory device having a data processor, a memory controller, and a non-volatile memory. The method includes identifying a communication bus that couples the memory device to a host device. The communication bus includes a plurality of functions, and is configured to communicate data based on a data communication protocol. The method further includes obtaining, from the data processor, first payload data that are generated based on a predefined device protocol; converting, based on the data communication protocol, the first payload data to a first outgoing data packet; and communicating the first outgoing data packet to the host device via a first function of the plurality of functions of the communication bus.

In another aspect of the application, a method is implemented for data communication at a memory device having a data processor, a memory controller, and a non-volatile memory. The method includes identifying a communication bus that couples the memory device to a host device. The communication bus is configured to communicate data based on a data communication protocol. The method further includes receiving, from the host device, incoming data via the communication bus; extracting an incoming data packet from the incoming data based on the data communication protocol, the incoming data packet complying with a first device protocol; providing the incoming data packet to the data processor; and generating, by the data processor, target data that complies with a second device protocol based on the incoming data packet.

In yet another aspect of the application, a non-transitory computer readable storage medium stores one or more programs. The one or more programs include instructions that, when executed by a memory device that includes a data processor, a memory controller, and a non-volatile memory, cause the memory device to perform any of the methods described in the above embodiments.

In yet another aspect of the application, a memory device includes a data processor, a memory controller, and a non-volatile memory. The memory device stores one or more programs including instructions to perform any of the methods described in the above embodiments.

In yet another aspect of the application, an electronic system includes a host device and a memory device coupled to the host device. The memory device further includes a data processor, a memory controller, and a non-volatile memory. The memory device stores one or more programs including instructions to perform any of the methods described in the above embodiments.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 is a block diagram of an example system module in a typical electronic device in accordance with some embodiments.

FIG. 2 is a block diagram of a memory system of an example electronic device having one or more memory access queues, in accordance with some embodiments.

FIG. 3 is a block diagram of an example computer system that includes a memory system having an internal processing capability, in accordance with some embodiments.

FIG. 4 is a block diagram of an example computer system including a memory system that operates in compliance with a storage access and transport protocol, in accordance with some embodiments.

FIG. 5 isa block diagram of an example electronic system configured to communicate data between a memory device and a host device, in accordance with some embodiments.

FIG. 6 is a block diagram of an example electronic system in which a host device and a memory device communicate with each other via PCIe functions, in accordance with some embodiments.

FIG. 7 is a block diagram of an example virtualization framework implemented by a memory device, in accordance with some embodiments.

FIG. 8 is a block diagram of an example electronic system in which a host device and a memory device communicate with each other via TCP/IP network tunneling, in accordance with some embodiments.

FIG. 9 is a block diagram of a memory device that features a virtualization architecture, in accordance with some embodiments.

FIG. 10 is a flow diagram of an example method for data communication at a memory device, in accordance with some embodiments.

FIG. 11 is a flow diagram of another example method for data communication at a memory device, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with storage capabilities.

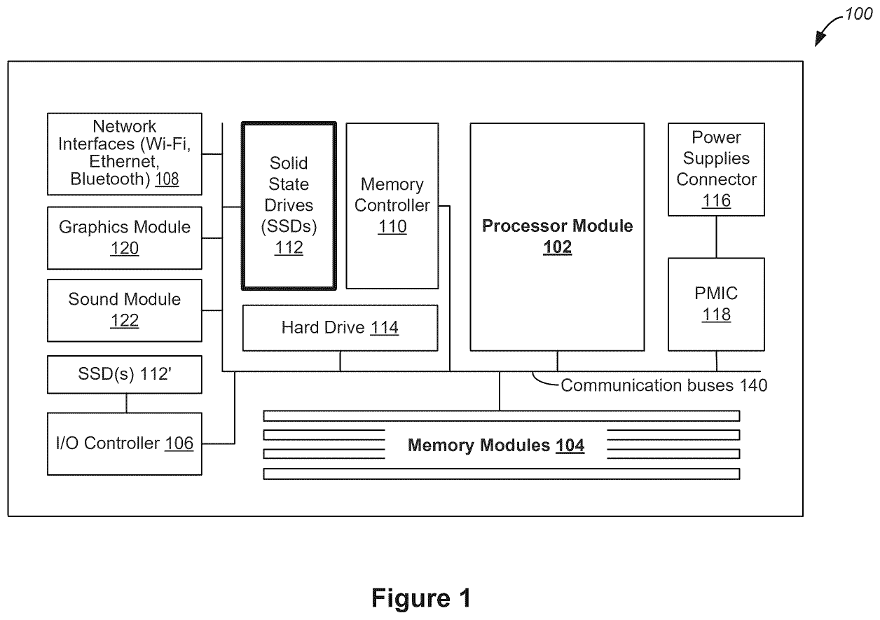

FIG. 1 is a block diagram of an example system module 100 in a typical electronic system in accordance with some embodiments. The system module 100 in this electronic system includes at least a processor module 102, memory modules 104 for storing programs, instructions and data, an input/output (I/O) controller 106, one or more communication interfaces such as network interfaces 108, and one or more communication buses 140 for interconnecting these components. In some embodiments, the I/O controller 106 allows the processor module 102 to communicate with an I/O device (e.g., a keyboard, a mouse or a trackpad) via a universal serial bus interface. In some embodiments, the network interfaces 108 includes one or more interfaces for Wi-Fi, Ethernet and Bluetooth networks, each allowing the electronic system to exchange data with an external source, e.g., a server or another electronic system. In some embodiments, the one or more communication buses 140 include circuitry (sometimes called a chipset) that interconnects and controls communications among various system components included in system module 100.

In some embodiments, the memory modules 104 include high-speed random-access memory (RAM), such as static random-access memory (SRAM), double data rate (DDR) dynamic random-access memory (DRAM), or other random-access solid state memory devices. In some embodiments, the memory modules 104 include non-volatile memory, such as one or more magnetic disk storage devices, optical disk storage devices, flash memory devices, or other non-volatile solid state storage devices. In some embodiments, the memory modules 104, or alternatively the non-volatile memory device(s) within the memory modules 104, include a non-transitory computer readable storage medium. In some embodiments, memory slots are reserved on the system module 100 for receiving the memory modules 104. Once inserted into the memory slots, the memory modules 104 are integrated into the system module 100.

In some embodiments, the system module 100 further includes one or more components selected from a memory controller 110, SSD(s) 112, an HDD 114, power management integrated circuit (PMIC) 118, a graphics module 120, and a sound module 122. The memory controller 110 is configured to control communication between the processor module 102 and memory components, including the memory modules 104, in the electronic system. The SSD(s) 112 are configured to apply integrated circuit assemblies to store data in the electronic system, and in many embodiments, are based on NAND or NOR memory configurations. The HDD 114 is a conventional data storage device used for storing and retrieving digital information based on electromechanical magnetic disks. The power supply connector 116 is electrically coupled to receive an external power supply. The PMIC 118 is configured to modulate the received external power supply to other desired DC voltage levels, e.g., 5V, 3.3V or 1.8V, as required by various components or circuits (e.g., the processor module 102) within the electronic system. The graphics module 120 is configured to generate a feed of output images to one or more display devices according to their desirable image/video formats. The sound module 122 is configured to facilitate the input and output of audio signals to and from the electronic system under control of computer programs.

Alternatively or additionally, in some embodiments, the system module 100 further includes SSD(s) 112′ coupled to the I/O controller 106 directly. Conversely, the SSD(s) 112 are coupled to the one or more communication buses 140. In an example, the one or more communication buses 140 operates in compliance with PCIe, which is a serial expansion bus standard for interconnecting the processor module 102 to, and controlling, one or more peripheral devices and various system components including components 110-122.

Further, one skilled in the art knows that other non-transitory computer readable storage media can be used, as new data storage technologies are developed for storing information in the non-transitory computer readable storage media in the memory modules 104, SSD(s) 112 or 112′, and HDD 114. These new non-transitory computer readable storage media include, but are not limited to, those manufactured from biological materials, nanowires, carbon nanotubes and individual molecules, even though the respective data storage technologies are currently under development and yet to be commercialized.

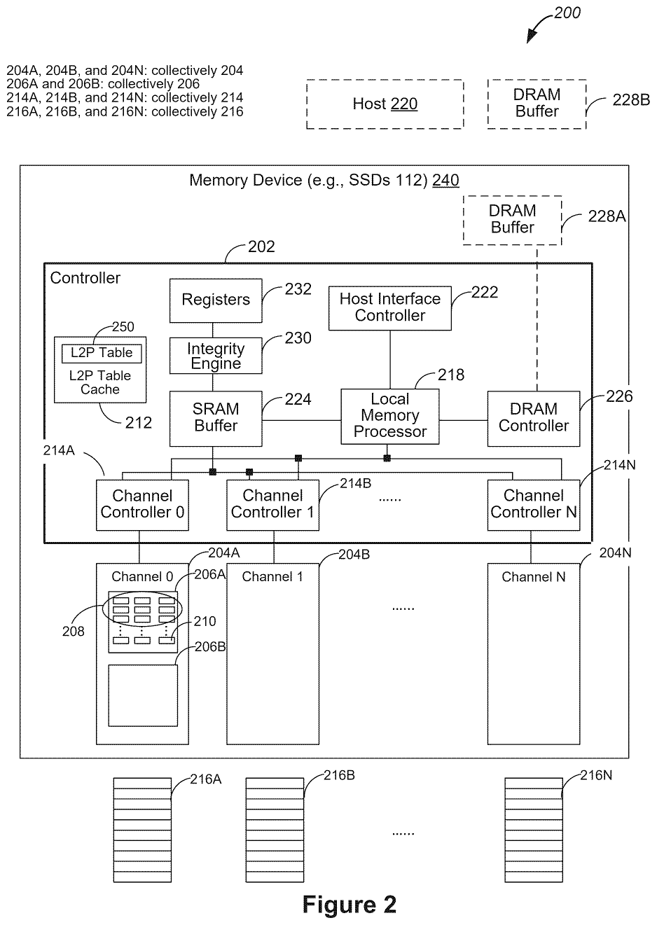

FIG. 2 is a block diagram of a memory system 200 of an example electronic device having one or more memory access queues, in accordance with some embodiments. The memory system 200 is coupled to a host device 220 (e.g., a processor module 102 in FIG. 1) and configured to store instructions and data for an extended time, e.g., when the electronic device sleeps, hibernates, or is shut down. The host device 220 is configured to access the instructions and data stored in the memory system 200 and process the instructions and data to run an operating system and execute user applications. The memory system 200 includes one or more memory devices 240 (e.g., SSD(s)). Each memory device 240 further includes a memory controller 202 and a plurality of memory channels 204 (e.g., channel 204A, 204B, and 204N). Each memory channel 204 includes a plurality of memory cells. The memory controller 202 is configured to execute firmware level software to bridge the plurality of memory channels 204 to the host device 220. In some embodiments, each memory device 240 is formed on a printed circuit board (PCB).

Each memory channel 204 includes one or more memory packages 206 (e.g., two memory dies). In an example, each memory package 206 (e.g., memory package 206A or 206B) corresponds to a memory die. Each memory package 206 includes a plurality of memory planes 208, and each memory plane 208 further includes a plurality of memory pages 210. Each memory page 210 includes an ordered set of memory cells, and each memory cell is identified by a respective physical address. In some embodiments, the memory device 240 includes a plurality of superblocks. Each superblock includes a plurality of memory blocks each of which further includes a plurality of memory pages 210. For each superblock, the plurality of memory blocks are configured to be written into and read from the memory system via a memory input/output (I/O) interface concurrently. Optionally, each superblock groups memory cells that are distributed on a plurality of memory planes 208, a plurality of memory channels 204, and a plurality of memory dies 206. In an example, each superblock includes at least one set of memory pages, where each page is distributed on a distinct one of the plurality of memory dies 206, has the same die, plane, block, and page designations, and is accessed via a distinct channel of the distinct memory die 206. In another example, each superblock includes at least one set of memory blocks, where each memory block is distributed on a distinct one of the plurality of memory dies 206 includes a plurality of pages, has the same die, plane, and block designations, and is accessed via a distinct channel of the distinct memory die 206. The memory device 240 stores information of an ordered list of superblocks in a cache of the memory device 240. In some embodiments, a host driver of the host device 220 manages the cache, which may thereby be referred to as a host managed cache (HMC).

In some embodiments, the memory device 240 includes a single-level cell (SLC) NAND flash memory chip, and each memory cell stores a single data bit. In some embodiments, the memory device 240 includes a multi-level cell (MLC) NAND flash memory chip, and each memory cell of the MLC NAND flash memory chip stores 2 data bits. In an example, each memory cell of a triple-level cell (TLC) NAND flash memory chip stores 3 data bits. In another example, each memory cell of a quad-level cell (QLC) NAND flash memory chip stores 4 data bits. In yet another example, each memory cell of a penta-level cell (PLC) NAND flash memory chip stores 5 data bits. In some embodiments, each memory cell can store any suitable number of data bits (e.g., X data bits, where X is greater than 5). In some embodiments, each memory cell can store any suitable number of data bits. Compared with the non-SLC NAND flash memory chips (e.g., MLC SSD, TLC SSD, QLC SSD, PLC SSD), the SSD that has SLC NAND flash memory chips operates with a higher speed, a higher reliability, and a longer lifespan, and however, has a lower device density and a higher price.

Each memory channel 204 is coupled to a respective channel controller 214 (e.g., controller 214A, 214B, or 214N) configured to control internal and external requests to access memory cells in the respective memory channel 204. In some embodiments, each memory package 206 (e.g., each memory die) corresponds to a respective queue 216 (e.g., queue 216A, 216B, or 216N) of memory access requests. In some embodiments, each memory channel 204 corresponds to a respective queue 216 of memory access requests. Further, in some embodiments, each memory channel 204 corresponds to a distinct and different queue 216 of memory access requests. In some embodiments, a subset (less than all) of the plurality of memory channels 204 corresponds to a distinct queue 216 of memory access requests. In some embodiments, all of the plurality of memory channels 204 of the memory device 240 corresponds to a single queue 216 of memory access requests. Each memory access request is optionally received internally from the memory device 240 to manage the respective memory channel 204 or externally from the host device 220 to write or read data stored in the respective memory channel 204. Specifically, each memory access request includes one of: a system write request that is received from the memory device 240 to write to the respective memory channel 204, a system read request that is received from the memory device 240 to read from the respective memory channel 204, a host write request that originates from the host device 220 to write to the respective memory channel 204, and a host read request that is received from the host device 220 to read from the respective memory channel 204. It is noted that system read requests (also called background read requests or non-host read requests) and system write requests are dispatched by a memory controller 202 to implement internal memory management functions including, but are not limited to, garbage collection, wear levelling, read disturb mitigation, memory snapshot capturing, memory mirroring, caching, and memory sparing.

In some embodiments, in addition to the channel controllers 214, the memory controller 202 further includes a local memory processor 218, a host interface controller 222, an SRAM buffer 224, and a DRAM controller 226. The local memory processor 218 accesses the plurality of memory channels 204 based on the one or more queues 216 of memory access requests. In some embodiments, the local memory processor 218 writes into and read from the plurality of memory channels 204 on a memory block basis. Data of one or more memory blocks are written into, or read from, the plurality of channels jointly. No data in the same memory block is written concurrently via more than one operation. Each memory block optionally corresponds to one or more memory pages. In an example, each memory block to be written or read jointly in the plurality of memory channels 204 has a size of 16 KB (e.g., one memory page). In another example, each memory block to be written or read jointly in the plurality of memory channels 204 has a size of 64 KB (e.g., four memory pages). In some embodiments, each page has 16 KB user data and 2 KB metadata. Additionally, a number of memory blocks to be accessed jointly and a size of each memory block are configurable for each of the system read, host read, system write, and host write operations.

In some embodiments, the local memory processor 218 stores data to be written into, or read from, each memory block in the plurality of memory channels 204 in an SRAM buffer 224 of the memory controller 202. Alternatively, in some embodiments, the local memory processor 218 stores data to be written into, or read from, each memory block in the plurality of memory channels 204 in a DRAM buffer 228A that is included in memory device 240, e.g., by way of the DRAM controller 226. Alternatively, in some embodiments, the local memory processor 218 stores data to be written into, or read from, each memory block in the plurality of memory channels 204 in a DRAM buffer 228B that is main memory used by the processor module 102 (FIG. 1). The local memory processor 218 of the memory controller 202 accesses the DRAM buffer 228B via the host interface controller 222.

In some embodiments, data in the plurality of memory channels 204 is grouped into coding blocks, and each coding block is called a codeword. For example, each codeword includes n bits among which k bits correspond to user data and (n-k) corresponds to integrity data of the user data, where k and n are positive integers. In some embodiments, the memory device 240 includes an integrity engine 230 (e.g., an LDPC engine) and registers 232, which include a plurality of registers or SRAM cells or flip-flops and are coupled to the integrity engine 230. The integrity engine 230 is coupled to the memory channels 204 via the channel controllers 214 and SRAM buffer 224. Specifically, in some embodiments, the integrity engine 250 has data path connections to the SRAM buffer 224, which is further connected to the channel controllers 214 via data paths that are controlled by the local memory processor 218. The integrity engine 230 is configured to verify data integrity and correct bit errors for each coding block of the memory channels 204.

In some embodiments, the memory system 200 includes an SSD having an L2P address indirection table 250 that stores physical addresses for a set of logical addresses, e.g., a logical block address (LBA). In some embodiments, the L2P address indirection table 250 is stored in an L2P table cache 212 included in the memory controller 202. Alternatively, in some embodiments, the memory system 200 includes a DRAM buffer 228A, and the L2P address indirection table 250 is stored in the DRAM buffer 228A. The local memory processor 218 of the memory controller 202 accesses the DRAM buffer 228A via a DRAM controller 226.

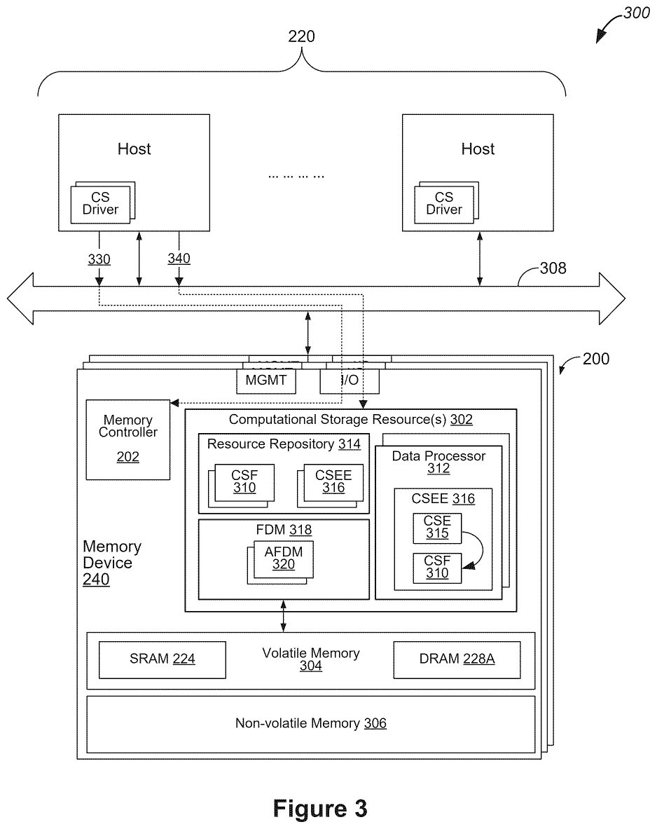

FIG. 3 is a block diagram of an example computer system 300 that includes a memory system 200 having an internal processing capability, in accordance with some embodiments. The memory system 200 is also called a computational storage device (CSD), and includes one or more memory devices 240 (e.g., SSDs). Each memory device 240 further includes a memory controller 202, a volatile memory 304, and a non-volatile memory 306 (e.g., memory channels 204). The host device(s) 220 and the one or more memory devices 240 of the memory system 200 are coupled to each other via a communication fabric 308. The communication fabric 308 includes the one or more communication buses 140 (FIG. 1) that operates in compliance with a data bus standard, e.g., PCIe, Ethernet standards. The host device(s) 220 are configured to issue memory access requests to write data into, and read data from, the non-volatile memory 306. The memory controller 202 accesses the non-volatile memory 306 in response to the memory access operations. Additionally, in some embodiments, the memory controller 202 dispatch system read requests (also called background read requests or non-host read requests) and system write requests to implement internal memory management functions including, but are not limited to, garbage collection, wear levelling, read disturb mitigation, memory snapshot capturing, memory mirroring, caching, and memory sparing. The volatile memory 304 of each memory device 240 further includes one or more of a L2P table cache 212, an SRAM buffer 224, and a DRAM buffer 228A, and is configured to store data temporarily while the memory controller 202 accesses the non-volatile memory 306 for memory accesses or internal memory management.

In some embodiments, the memory controller 202 is dedicated to processing the memory access requests and internal memory management functions. A memory device 240 further includes one or more computational storage resources (CSRs) 302 configured to implement data processing operations locally on the memory device 240. A set of predefined data processing operations are implemented to perform a computational storage function (CSF) 310, which is distinct from the memory access and internal memory management functions performed by the memory controller 202. In some embodiments, a computational storage resource 302 processes user data that are received from the host device(s) 220 or extracted from the non-volatile memory 306 during the data processing operations. In some embodiments, the processed data are stored into the non-volatile memory 306 or sent to the host device(s) 220 via the communication fabric 308. Further, in some embodiments, a subset of the user data, the process data, and intermediate data generated during the data processing operations is temporarily stored in the volatile memory 304 (e.g., SRAM buffer 224, DRAM buffer 228A).

In some embodiments, the computational storage resource 302 includes one or more data processors 312 and a resource repository 314. The one or more data processors 312 provide a computational storage engine configured to perform one or more predefined data processing operations, e.g., associated with a computational storage function 310 of the computational storage resource 302. In some embodiments, the computational storage function 310 corresponds to an in-memory application associated with the computational storage engine, and is implemented via the computational storage engine in the memory device 240. The resource repository 314 is a centralized location (e.g., memory space) storing various types of data and resources, such as software libraries, configuration files, media files, or any other type of data needed for a plurality of computational storage functions 310 performed by the computational storage resource 302. For example, the resource repository 314 stores instructions for creating a computational storage engine environment (CSEE) 316 and instructions for implementing a set of data processing operations associated with a computational storage function 310 in the CSEE 316. Instructions are loaded from the resource repository 314 and executed by the data processor 312, thereby creating the CSEE 316 where the computational storage engine 315 is executed to implement data processing operations associated with the computational storage function 310.

In some embodiments, the computational storage resource 302 further includes a function data memory (FDM) 318 for storing data that are used or generated by the computational storage engine 315 for performing a computational storage function 310. In some embodiments, the function data memory 318 is included in the volatile memory 304. For example, the function data memory 318 corresponds to a portion of the DRAM buffer 228A (FIG. 2). In another example, the function data memory 318 corresponds to a portion of the SRAM buffer 224 (FIG. 2). Further, in some embodiments, a portion of the function data memory 318 (also called an allocated FDM (AFDM) 320) is allocated for one or more instances of a computational storage function 310.

In some embodiments, a host device 22 issues a memory read or write request 330 to a memory device 240 of the memory system 200, and the memory controller 202 of the memory device 240 receives the memory read or write request 330 and accesses the non-volatile memory 306 accordingly. Alternatively, in some embodiments, a host device 22 issues a data processing request 340 to the memory device 240, and a data processor 312 of the computational storage resource 302 (e.g., the computational storage engine 315) receives the data processing request 340 and processes user data extracted from the data processing request or the non-volatile memory 306.

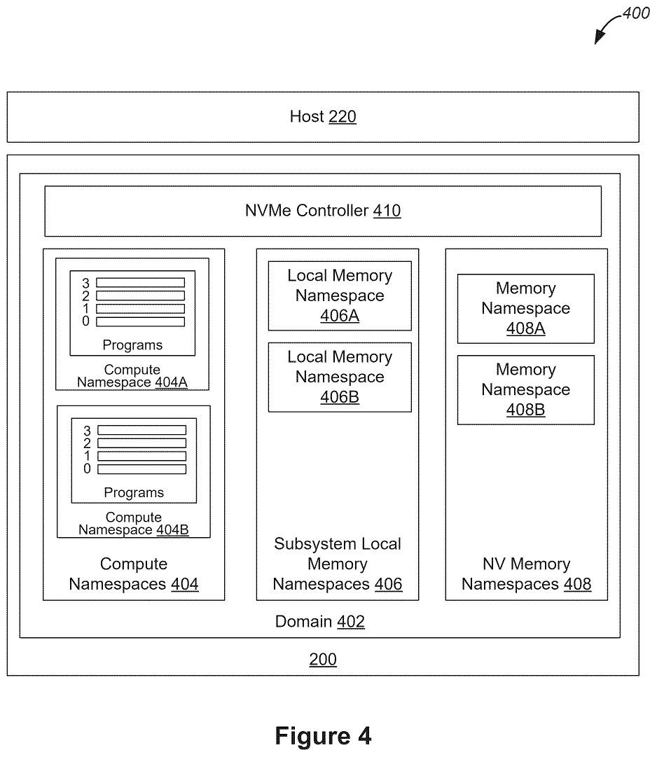

FIG. 4 is a block diagram of an example computer system 400 including a memory system 200 that operates in compliance with a storage access and transport protocol (e.g., NVMe), in accordance with some embodiments. The memory system 200 includes one or more memory devices 240 each of which corresponds to a domain 402 according to the storage access and transport protocol. Each domain 402 corresponding to a respective memory device 240 includes a one or more compute namespaces 404, local memory namespaces 406, memory namespaces 408, and a domain controller 410. Each namespace is a collection of LBAs accessible to, or associated with, a respective one of the plurality of programs.

A memory device 240 includes one or more processors having a computation capability (e.g., a memory controller 202, a data processor 312), a volatile memory 304 (e.g., a cache 212, an SRAM buffer 224, a DRAM buffer 228A), and a non-volatile memory 306. When the memory device 240 executes a plurality of programs, resources of the memory controller 202, the volatile memory 304, and the non-volatile memory 306 are allocated to implement the plurality of programs based on the storage access and transport protocol (e.g., NVMe). A plurality of compute namespaces 404 (e.g., 404A and 404B) correspond to, are configured to provide, instructions of the plurality of programs executed by the one or more programs of the memory device 240. Resources of the volatile memory 304 are allocated based on a plurality of local memory namespaces 406 (e.g., 406A and 406B) to facilitate execution of the plurality of programs by the memory device 240, so are resources of the non-volatile memory 306 allocated based on a plurality of memory namespaces 408 (e.g., 408A and 408B). It is noted that, in some embodiments, a number of programs is not limited to 2 and may be greater than 2, thereby creating more than two namespaces in each type of compute namespaces 404, 406, or 408.

In an example, a compute namespace 404A corresponds to a respective local memory namespace 406A and a respective non-volatile memory namespace 408A. The compute namespace 404A provides instructions of a corresponding program for execution by the one or more processors of the memory device 240. In some embodiments, input data that are processed, and output data that are generated, by these instructions are temporarily stored based on the local memory namespace 406A. In some embodiments, the input data are extracted based on the non-volatile memory namespace 408A, and the output data are stored based on the non-volatile memory namespace 408A. By these means, namespace allocation and utilization in the domain 402 corresponding to the memory device 240 are managed according to the storage access and transport protocol.

In some embodiments, the storage access and transport protocol includes an NVMe protocol for accessing flash storage (e.g., SSDs) via a PCIe bus. The PCIe bus is configured to support a plurality of parallel command queues (e.g., on an order of 104 queues), thereby operating with a substantially high throughput and a substantially fast response time. In some embodiments, the host device 220 is configured to communicate and interact with each memory device 240 (e.g., SSD) as a standard NVMe storage device using the NVMe protocol. The host device 220 is configured to read and write data and implement data processing operations on the memory device 240 using NVMe commands.

In some embodiments, the host device 220 executes an operating system (e.g., a Linux operating system) on a host side, and the CSRs 302 (FIG. 3) of the memory device 240 executes the operating system (e.g., an embedded Linux operating system) on a storage side.

In some embodiments, a memory device 240 (also called a storage device) includes a plurality of processing cores, and is transformed to a computational storage device (CSD) by activating a computational storage configuring two separate subsets of processing cores to a memory controller 202 and a data processor (e.g., data processor 312 in FIG. 3), respectively. The data processor is configured to process internal computational storage operations (e.g., data processing operations) locally on the memory device 240, while the memory controller 202 of the memory device 240 specializes in performing generic storage functions including memory access functions (e.g., input/output (I/O) access operations) and internal memory management functions. In some embodiments, the memory controller 202 and the data processor of the memory device 240 at least partially share certain hardware resources in a time-multiplexed manner. The memory device 240 may operate in a computational storage elevation (CSE) mode, when the hardware resources (e.g., processing cores) are allocated to the computational storage functions or adjusted between the memory access functions and the computational storage functions.

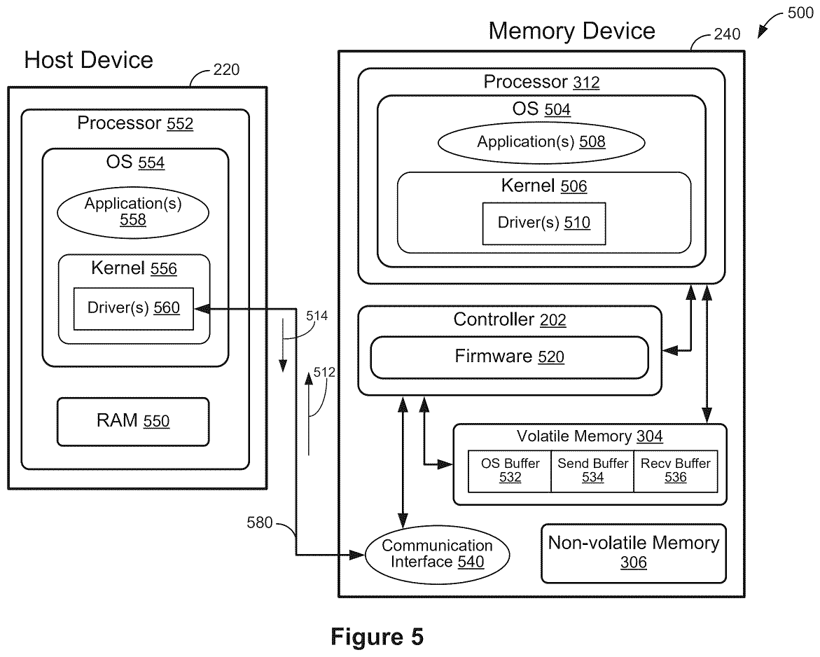

FIG. 5 is a block diagram of an example electronic system 500 configured to communicate data between a memory device 240 and a host device 220, in accordance with some embodiments. The host device 220 and the memory device 240 are coupled to one another, and communicate data via a communication bus 580. In some embodiments, the communication bus 580 includes a PCIe communication bus. In an example, the communication bus 580 is configured to communicate data between the memory device 240 and the host device 220 according to a PCIe interface standard. In some embodiments, the memory device 240 sends an outgoing data packet 512 to the host device 220 via the communication bus 580. In some embodiments, the outgoing data packet 512 is structured in one or more protocol formats, e.g., including a subset of TCP/IP, NVMe, PCIe, Virtual I/O Device (VirtIO), and other types. Further, in some embodiments, the outgoing data packet 512 includes one or more data segments, and each data segment of the outgoing data packet 512 includes a respective protocol-specific header that has a respective data format defined based on a respective protocol format. For example, a data segment includes a header defined according to VirtIO, which is an interface standard for virtualization that facilitates efficient data communication between virtual machines and physical hardware (e.g., virtual device driver(s)).

In some embodiments, the memory device 240 receives an incoming data packet 514 that are sent from the host device 220 via the communication bus 580, and the incoming data packet 514 is structured in one or more protocol formats, e.g., including a subset of TCP/IP, NVMe, PCIe, VirtIO, and other types. In some embodiments, the incoming data packet 514 that is structured in one or more protocol formats are encapsulated in a data packet structured in other format(s). For example, a data packet structured in NVMe or a data packet structured in VirtIO is encapsulated in a data packet structured in PCIe. In some embodiments, the host device 220 receives the outgoing data packet 512 sent from the memory device 240 via the communication bus 580, and the memory device 220 receives the incoming data packet 514 sent from the host device 220 via the communication bus 580. Bidirectional communication is established within the communication bus 580 coupled between the memory device 240 and the host device 220. In some embodiments, the memory device 240 acts as a standard NVMe storage device (e.g., a physical device) to the host device 220. The host device 220 accesses data stored in the memory device 240 and controls the memory device 240 using standard NVMe commands. Alternatively, in some embodiments, the memory device 240 acts as a VirtIO virtual network device (e.g., a virtual device) to the host device 220. The host device 220 accesses data stored in the memory device 240 and controls the memory device 240 using virtual device driver(s) based on VirtIO.

In some embodiments, the host device 220 includes at least a host processor 552 and a random access memory (RAM) 550. The host processor 552 is configured to execute a host operating system 554 (e.g., Linux) jointly with the memory device 240. The host operating system 554 includes one or more of: host application(s) 558 for implementing predefined functions and a host kernel 556 including one or more data drivers 560. For example, the host kernel 556 includes one of the one or more data drivers 560, e.g., application driver(s) associated with the host application(s) 558, a PCIe/NVMe driver associated with data communication via the communication bus 580, and a VirtIO network driver for emulating a VirtIO device.

The memory device 240 includes a data processor 312, a memory controller 202, a memory buffer 530, a non-volatile memory 306, and an input/output data interface 540. The input/output data interface 540 is configured to couple to the communication bus 580 and communicate data via the communication bus 580. The communication bus 580 is configured to communicate data (e.g., data packets 512 and 514) between the input/output data interface 540 and the host device 220, e.g., according to the PCIe interface standard. The data processor 312 is coupled to the input/output data interface 540. In some embodiments, the data processor 312 is configured to execute an embedded operating system 504 (e.g., Linux). The embedded operating system 504 includes device application(s) 508 and an embedded kernel 506. The embedded kernel 506 includes one or more device drivers 510. For example, the embedded kernel 506 includes one of the one or more device drivers 510, e.g., a block device driver, a VirtIO network driver.

In some embodiments, the memory controller 202 is coupled to the data processor 312, the memory buffer 530, and the input/output data interface 540. The memory controller 202 is distinct from the data processor 312 and configured to execute a firmware 520. In some embodiments, the firmware 520 of the memory controller 202 includes an NVMe firmware for implementing storage functions.

The memory buffer 530 is coupled to the data processor 312 and the memory controller 202. The memory buffer 530 includes a first buffer portion 532 (e.g., an operating system (OS) buffer 532) allocated to the data processor 312 and a second buffer portion allocated to the memory controller 202. In some embodiments, the second buffer portion includes an outgoing buffer portion 534 (e.g., a send buffer 534) and a receiving buffer portion 536 (e.g., a receive buffer 536). The send buffer 534 is configured to store data to be sent over the communication bus 580 and the receive buffer 536 is configured to store data received from the communication bus 580. In some embodiments, the memory buffer 530 includes a double data rate dynamic random-access memory (DDR DRAM). In some embodiments, the memory buffer 530 includes the DRAM buffer 228A (FIG. 2), the SRAM buffer 224 (FIG. 2), or both.

The non-volatile memory 306 of the computational storage device 240 is coupled to the data processor 312 and the memory controller 202. The non-volatile memory 306 includes a plurality of memory blocks (e.g., corresponding to a plurality of memory channels 204 in FIG. 2). A subset of the plurality of memory blocks of the non-volatile memory 306 is reserved for the data processor 312. In some embodiments, the non-volatile memory 306 includes NAND flash memory.

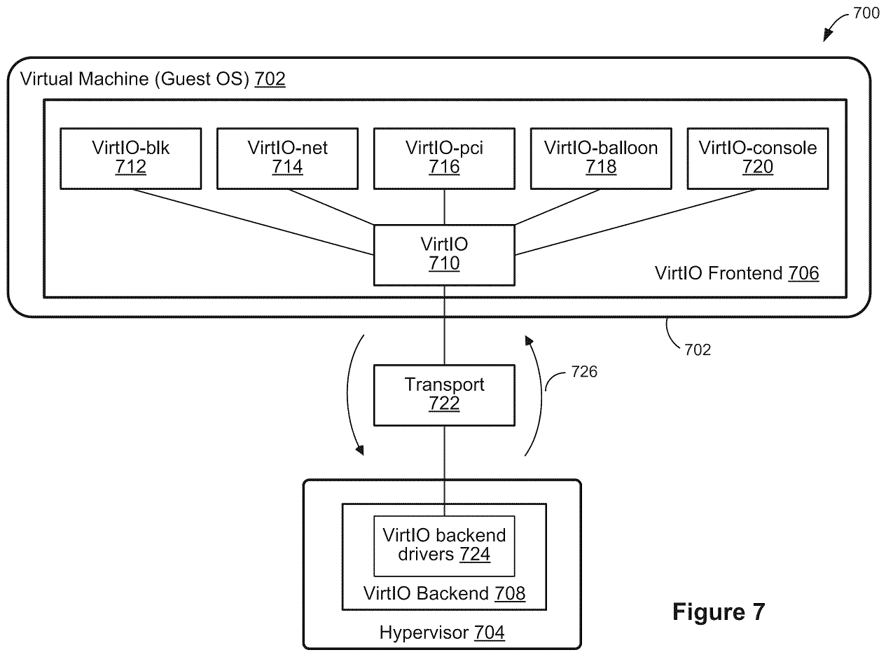

In some embodiments, the memory device 240 is exposed to the host device 220 as a virtual device through a paravirtualized interface. In some embodiments, the parvirtualized interface of the memory device 240 is formed based on a hypervisor and a virtual machine (e.g., hypervisor 704 and virtual machine 702 in FIG. 7). More specifically, in some embodiments, the device processor 312 performs as a virtual machine of the host device 220 via the embedded operating system 504, and the memory device 240 allocates a subset of processing resources to provide the hypervisor and the virtualization firmware for communicating with and managing the device processor 312. Compared with full virtualization, the virtual machine of paravirtualization is configured to communicate directly with the hypervisor. This paravirtualization configuration allows the virtual machine to make hypercalls to the hypervisor for resource management and I/O operations, thereby reducing virtualization overhead and enhancing total performance.

### Paravirtualized Devices as a Tunneling Mechanism

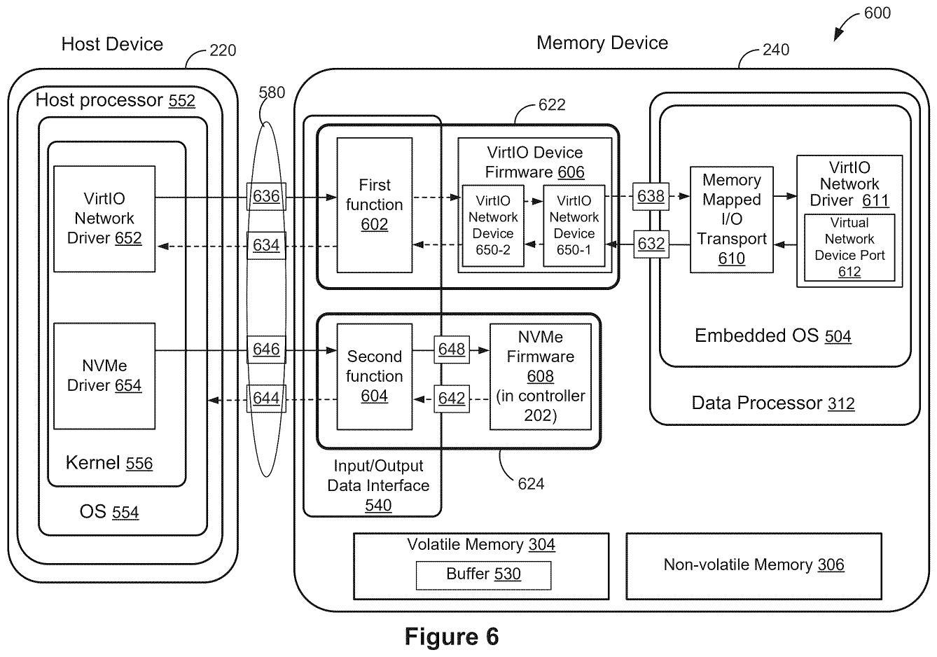

FIG. 6 is a block diagram of an example electronic system 600 in which a host device 220 and a memory device 240 communicate with each other via PCIe functions, in accordance with some embodiments. The memory device 240 is a computational storage device and is coupled to the host device 220 via a communication bus 580. More specifically, the memory device 240 includes at least a data processor 312, a memory controller 202, a volatile memory 304 including a memory buffer 530, and a non-volatile memory 306. The memory device 240 further includes an input/output data interface 540 for driving the communication bus 580 between the host device 220 and the memory device 240 based on a data communication protocol (e.g., PCIe). In some embodiments, the non-volatile memory 306 includes one or more NAND flash chips. The memory controller 202 is configured to access and manage data stored in the one or more NAND flash chips. The data processor 312 is configured to process the data stored in the one or more NAND flash chips.

In some embodiments, the host device 220 of the electronic system 600 includes at least a host processor 552. The host processor 552 is configured to execute a host operating system 554 (e.g., Linux) having a host kernel 556. In some embodiments, the host kernel 656 includes one or more data drivers 560 having a VirtIO network driver 652 and an NVMe driver 654. The VirtIO network driver 652 of the host kernel 656 is configured to communicate data (e.g., data packets) with the memory device 240 based on the VirtIO interface standard. The NVMe driver 654 of the host kernel 656 is configured to communicate data (e.g., data packets) with the memory device 240 based on the NVMe interface standard.

In some embodiments, the data processor 312 of the memory device 240 of the electronic system 600 is configured to execute an embedded operating system 504 (e.g., Linux). In some embodiments, the embedded operating system 504 is unmodified to support a predefined device protocol (e.g., VirtIO). For example, the embedded operating system 504 includes a standard Linux kernel that supports VirtIO frontend drivers and (e.g., discussed below in FIG. 7). In some embodiments, the embedded operating system 504 includes a VirtIO network driver 611 (e.g., drivers of a VirtIO frontend 706 in FIG. 7) in compliance with a predefined device protocol (e.g., VirtIO). The embedded operating system 504 provides, at the VirtIO network driver 611, a virtual network device port 612 for data communication between the data processor 312 and the host processor 552 via a memory mapped I/O (MMIO) transport 610. In some embodiments, the MMIO transport 610 is a memory address mapping mechanism configured to manage data communication between the embedded operating system 504 and the input/output data interface 540. The MMIO transport 610 provides a unified memory access for the communication bus 580 and the input/output data interface 540. In some embodiments, control registers and data buffers of the input/output data interface 540 are mapped to an address space when the data processor 312 communicates data with the host device 220 via the input/output data interface 540.

In some embodiments, the communication bus 580 includes a PCIe communication bus. In some embodiments, the communication bus 580 includes a plurality of functions, which support a range of operations, such as data transmitting, data receiving, system controlling, and more. In some embodiments, the plurality of functions of the communication bus 580 further include a first function 602 and a second function 604. Moreover, in some embodiments, each function of the plurality of functions of the communication bus 580 includes a physical function (e.g., PCIe physical function) or a virtual function (e.g., PCIe virtual function). For example, a PCIe physical function manages capabilities and resources of a PCIe device, and a PCIe virtual function allows a virtual machine to access the PCIe device. In some embodiments, the plurality of functions of the communication bus 580 are applied jointly to utilize resources of the input/output data interface 540. Further, in some embodiments, each physical function of the plurality of functions of the communication bus 580 manages more than one virtual functions. The number of virtual functions that a physical function can support depends on the specification of the data communication protocol (e.g., PCIe).

In some embodiments, the memory device 240 of the electronic system 600 includes a VirtIO device firmware 606 and an NVMe firmware 608. In some embodiments, the VirtIO device firmware 606 is a virtual device firmware and distinct from the memory controller 202. In some embodiments, the VirtIO device firmware 606 is executed by the memory controller 202. In some embodiments, the VirtIO device firmware 606 is configured to drive data communication between virtual function(s) of the communication bus 580 and the data processor 312. For example, the VirtIO device firmware 606 obtains input data having a PCIe data format, generates user data having a VirtIO data format based on the input data, and provides the user data to the data processor 312 via the MMIO transport 610 and the virtual network device port 612. Further, in some embodiments, the memory device 240 enumerates the virtual network device port 612 to the communication bus 580 through the VirtIO device firmware 606, such that the virtual network device port 612 is discovered and identified to the communication bus 580 and the input/output data interface 540. In some embodiments, the memory device 240 maps the virtual network device port 612 to the communication bus 580 through the VirtIO device firmware 606. In some embodiments, the VirtIO device firmware 606 is a software layer that configures the data processor 312 to act as a virtual machine to the host device 220.

More specifically, in some embodiments, the VirtIO device firmware 606 acts as one or more VirtIO network devices 650 (e.g., VirtIO network device 650-1 to VirtIO network device 650-m, where m is an integer greater than one) to the host operating system 554 and the embedded operating system 504. In some embodiments, the virtual device firmware 606 exposes (e.g., announces) itself as the one or more VirtIO network devices 650 in compliance with VirtIO. For example, the virtual device firmware 606 exposes (e.g., announces) itself as a first VirtIO network device 650-1 via the MMIO transport 610 and also as a second VirtIO network device 650-2 via the first function 602 and the communication bus 580. In some embodiments, the VirtIO network driver 611 of the embedded operating system 504 detects and enumerates the one or more VirtIO network devices 650 exposed (e.g., announced) by the virtual device firmware 606 via the MMIO transport 610. In some embodiments, the VirtIO network driver 652 of the host kernel 656 detects and enumerates the memory device 240 as the one or more VirtIO network devices 650 in compliance with VirtIO exposed (e.g., announced) by the virtual device firmware 606 via the communication bus 580. In some embodiments, the virtual device firmware 606 facilitates a network communication between the VirtIO network driver 611 of the embedded operating system 504 and the VirtIO network driver 652 of the host kernel 656 by connecting (e.g., communicatively coupling) the one or more VirtIO network devices 650 with each other. For example, in some embodiments, the first VirtIO network device 650-1 connects (e.g., communicatively couples) to the second VirtIO network device 650-2.

In some embodiments, the NVMe firmware 608 is executed by the memory controller 202. In some embodiments, the NVMe firmware 608 is a computational module responsible for NVMe storage functionality. The NVMe firmware 608 controls the memory controller 202 and the input/output data interface 540. The NVMe firmware 608 is configured to drive data communication between physical function(s) of the communication bus 580 and the memory controller 202, allowing the memory controller 202 to implement memory access operations.

In some embodiments, the memory device 240 of the electronic system 600 provides a virtual communication channel for sending data from the memory device 240 to the host device 220. The memory device 240 obtains, from the data processor 312, first payload data 632 that are generated based on a predefined device protocol (e.g., VirtIO). The memory device 240 also converts, based on the data communication protocol (e.g., PCIe), the first payload data 632 to a first outgoing data packet 634. The memory device 240 further communicates the first outgoing data packet 634 to the host device 220 via a first function 602 (e.g., PCIe virtual function) of the plurality of functions of the communication bus 580. In some embodiments, the memory device 240 provides, at the memory controller 202, a virtual network device firmware (e.g., the VirtIO device firmware 606) to communicate the first outgoing data packet 634.

In some embodiments, the memory device 240 of the electronic system 600 provides the virtual communication channel for receiving data from the host device 220 to the memory device 240. The memory device 240 receives, from the host device 220, first incoming data 636 via the first function 602 (e.g., PCIe virtual function) of the communication bus 580. The memory device 240 also extracts a first incoming data packet 638 from the first incoming data 636 based on the data communication protocol (e.g., PCIe). The first incoming data packet 638 complies with the predefined device protocol (e.g., VirtIO). The memory device 240 further provides the first incoming data packet 638 to the data processor 312 for additional processing.

In some embodiments, the memory device 240 of the electronic system 600 provides a physical communication channel for sending data from the memory device 240 to the host device 220. The memory device 240 obtains, from the memory controller 202, second payload data 642 that are generated based on a data transfer protocol (e.g., NVMe). The memory device 240 also converts, based on the data communication protocol (e.g., PCIe), the second payload data 642 to a second outgoing data packet 644. The memory device 240 further communicates the second outgoing data packet 644 to the host device 220 via a second function 604 (e.g., PCIe physical function) of the plurality of functions of the communication bus 580.

In some embodiments, the memory device 240 of the electronic system 600 provides the physical communication channel for receiving data from the host device 220 to the memory device 240. The memory device 240 receives, from the host device 220, second incoming data 646 via the second function 604 (e.g., PCIe physical function) of the plurality of functions of the communication bus 580. The memory device 240 further extracts a second incoming data packet 648 from the second incoming data based on the data communication protocol (e.g., PCIe). The second incoming data packet 648 complies with the data transfer protocol (e.g., NVMe). The memory device 240 further provides the second incoming data packet 648 to the memory controller 202.

In some embodiments, a data packet is a formatted unit of data communicated within network linking devices (e.g., the host device 220 and the memory device 240). The data packet serves as a fundamental block used for transmitting data based on different data communication protocols (e.g., PCIe). In some embodiments, payload data is part of a data packet that includes actual information being communicated. In some embodiments, payload data includes meaningful contents that a sender (e.g., the memory device 240) intends to deliver to a receiver (e.g., the host device 220).

In some embodiments, the memory device 240 of the electronic system 600 provides a plurality of device interfaces for communicating data (e.g., receiving data and sending data) between the host device 220 and the memory device 240. Each device interface of the plurality of device interfaces corresponds to a respective distinct function (e.g., physical or virtual function) of the plurality of functions and a respective protocol (e.g., VirtIO, NVMe).

More specifically, in some embodiments, the plurality of device interfaces include a first device interface 622 (e.g., a VirtIO network device interface). The first device interface 622 is built based on the first function 602 of the plurality of functions of the communication bus 580 and the predefined device protocol (e.g., VirtIO). The first device interface 622 is configured to expose the memory device 240 as a virtual data processing device (e.g., a virtualized network card, a virtual network device) including the data processor 312 to the host device 220. In some embodiments, the first device interface 622 is configured to expose the data processor 312 for in-memory data processing.

In some embodiments, the plurality of device interfaces include a second device interface 624 (e.g., a storage device interface). The second device interface 624 is built based on the second function 604 of the plurality of the communication bus 580 and the data transfer protocol (e.g., NVMe). The second device interface 624 is configured to expose the memory device 240 as a storage device (e.g., an NVMe storage device) including the memory controller 202 to the host device 220. In some embodiments, the second device interface 624 is configured to expose the memory controller 202 for accessing memory cells.

In some embodiments, the exposed virtual data processing device (e.g., exposed virtualized network card, exposed virtual network device) associated with the memory device 240 is discovered and initialized by the VirtIO network driver 652 of the host kernel 556. In some embodiments, the exposed storge device (e.g., exposed NVMe storage device) associated with the memory device 240 is discovered and initialized by the NVMe driver 654 of the host kernel 556. Further, in some embodiments, the exposed virtual data processing device is configured to connect the host operating system 554 directly to the virtual network device port 612 of the embedded operating system 504, such that a network tunnel between the host operating system 554 and the embedded operating system 504 is formed.

In some embodiments, the memory device 240 of the electronic system 600 implements at least two of the plurality of device interfaces (e.g., the first device interface 622 and the second device interface 624) on the communication bus 580 according to a time-splitting scheme (e.g., time-division multiple access, time-division duplexing). For example, the first device interface 622 and the second device interface 624 share the communication bus 580 and divide available transmission time of the communication bus 580 for sending and/or receiving data into different time segments. In another example, the time-splitting scheme can avoid data collision by dynamically allocating data packets (e.g., data 634, 636, 644, and 646) into the first device interface 622 and the second device interface 624 based on actual traffic demand.

In some embodiments, the memory device 240 of the electronic system 600 implements at least two of the plurality of device interfaces (e.g., the first device interface 622 and the second device interface 624) on the communication bus 580 concurrently using distinct physical bandwidths of the communication bus 580. For example, a bandwidth-splitting scheme based on frequency-division multiple access assigns data signals that are transmitted through the first device interface 622 and the second device interface 624 to specific frequency regimes for concurrent data transmissions. In another example, a bandwidth-splitting scheme based on orthogonal frequency-division multiplexing assigns data signals that are transmitted through the first device interface 622 and the second device interface 624 to different sub-carriers in a frequency domain.

Stated another way, in some embodiments, the electronic system 600 provides a network tunnel for communicating data packets between the host device 220 and the memory device 240 based on multiple protocols/standards (e.g., VirtIO, TCP/IP). The network tunnel is built through the first device interface 622 (e.g., a VirtIO network device interface) and the virtual network device port 612. In some embodiments, the VirtIO network driver 652 of the host kernel 556 facilities the network tunnel by offloading complex hardware management (e.g., associated with TCP/IP stack) and maintains security between the host operating system 554 and the embedded operating system 504. More details on the VirtIO-based network tunnel are discussed below with reference to FIG. 7.

In some embodiments, the memory device 240 of the electronic system 600 provides, based on the embedded operating system 504, a paravirtualized interface in compliance with the predefined device protocol (e.g., VirtIO). The memory device 240 further routes, through the paravirtualized interface, a plurality of data packets (e.g., data 634 and 638) between the memory device 240 and the host device 220. In some embodiments, the memory device 240 is exposed to the host device 220 as a virtual device through the paravirtualized interface. In some embodiments, the parvirtualized interface of the memory device 240 is formed based on a hypervisor and a virtual machine (e.g., hypervisor 704 and virtual machine 702 in FIG. 7).

FIG. 7 is a block diagram of an example virtualization framework 700 implemented by a memory device 240, in accordance with some embodiments. In some embodiments, the virtualization framework 700 (e.g., on a standard Linux kernel) is implemented in compliance with VirtIO, and configured to provide a virtual network device port 612 for an embedded operating system 504. More specifically, in some embodiments, the virtualization framework 700 includes a virtual machine 702 (e.g., guest operation system), a hypervisor 704, and a VirtIO transport layer 722. In some embodiments, the virtual machine 702 includes a VirtIO frontend 706 having a plurality of frontend drivers for receiving I/O requests from user processes. In some embodiments, the hypervisor 704 includes a VirtIO backend 708 having one or more VirtIO backend drivers 724 that create the virtual machine 702 for device emulation. In some embodiments, the VirtIO transport layer 722 provides a channel 726 between the VirtIO frontend 706 and the VirtIO backend 708 and communicates data (e.g., based on Virtqueues, which is a mechanism for bulk data transport). In some embodiments, the VirtIO backend 708 is an implementation of device requirements in compliance with VirtIO. The VirtIO backend 708 serves as an intermediate layer bridging the virtual machine 702 and physical hardware (e.g., the data processor 312, the memory controller 202). In some embodiments, the VirtIO backend 708 is included in the VirtIO device firmware 606.

In some embodiments, the plurality of frondend drivers of the VirtIO frontend 706 includes a VirtIO core function driver 710 (e.g., “Virtio”), a VirtIO block device driver 712 (e.g., “Virtio-blk”), a VirtIO network device driver 714 (e.g., “Virtio-net”), a VirtIO PCIe device driver 716 (e.g., “Virtio-pci”), a VirtIO memory ballooning device driver 718 (e.g., “Virtio-balloon”), and a VirtIO console device driver 720 (e.g., “Virtio-console”). In some embodiments, the VirtIO core function driver 710 includes core functions for managing an interface between the virtual machine 702 and the hypervisor 704. In some embodiments, the VirtIO block device driver 712 is configured to provide a block device that allows the virtual machine 702 to access virtual storage spaces. In some embodiments, the VirtIO network device driver 714 is configured to provide a virtual network device (e.g., a VirtIO virtual network device) for the virtual machine 702 to have network connectivity. In some embodiments, the VirtIO PCIe device driver 716 is configured to provide a PCIe device for a PCIe bus (e.g., the communication bus 580 in FIG. 6) and a PCIe interface (e.g., the input/output data interface 540). In some embodiments, the VirtIO memory ballooning device driver 718 is configured to provide dynamic memory management by allowing the hypervisor 704 to reclaim or allocate memory to/from the virtual machine 702. In some embodiments, the VirtIO console device driver 720 is configured to provide a virtual console interface (e.g., a consoled device) for the virtual machine 702. In some embodiments, the virtual console is used for data managing, data debugging, and/or data logging. In some embodiments, the VirtIO frontend 706 is configured to support at least one of a plurality of input/output devices including a block device, a consoled device, and a network device.

In some embodiments, the VirtIO frontend 706 is implemented in a standard Linux kernel of the embedded operating system 504, and the embedded operating system 504 remains unmodified. The only modification required for the memory device 240 is a firmware update (e.g., providing the VirtIO device firmware 606) for supporting the network tunnel through the first device interface 622 and the virtual network device port 612. There is no need to provide custom software or drivers for the host operating system 554 or to provide a custom Linux kernel for the embedded operating system 504. In some embodiments, the electronic system 600 provides a fast and secure solution for data communication and requires minimal maintenance with fewer disruptive firmware updates. In some embodiments, the electronic system 600 is configured to implement multiple virtualization protocols. In some embodiments, the electronic system 600 provides a simple solution to deploy and offload programs to the embedded operating system 504 using networks (e.g. Kubernetes).

In some embodiments, the electronic system 600 decouples computation and storage functions using a dual communication channel configuration, which includes (i) a virtual communication channel formed based on the first device interface 622 (e.g., a VirtIO network device interface), the MMIO transport 610, and the virtual network device port 612 and (ii) a physical communication channel formed based on the second device interface 624 (e.g., an NVMe storage device interface). In some embodiments, the dual communication channel configuration isolates computation engine(s) (e.g., associated with the first device interface 622) from storage functions (e.g., associated with second device interface 624). Further, in some embodiments, the virtual communication channel and the physical communication channel operate independently and allow the memory device 240 to focus on core tasks without being interrupted by an interference between the first device interface 622 and the second device interface 624. In some embodiments, the dual communication channel configuration improves an overall security level of the electronic system 600.

### Generic Network Tunneling for TCP/IP

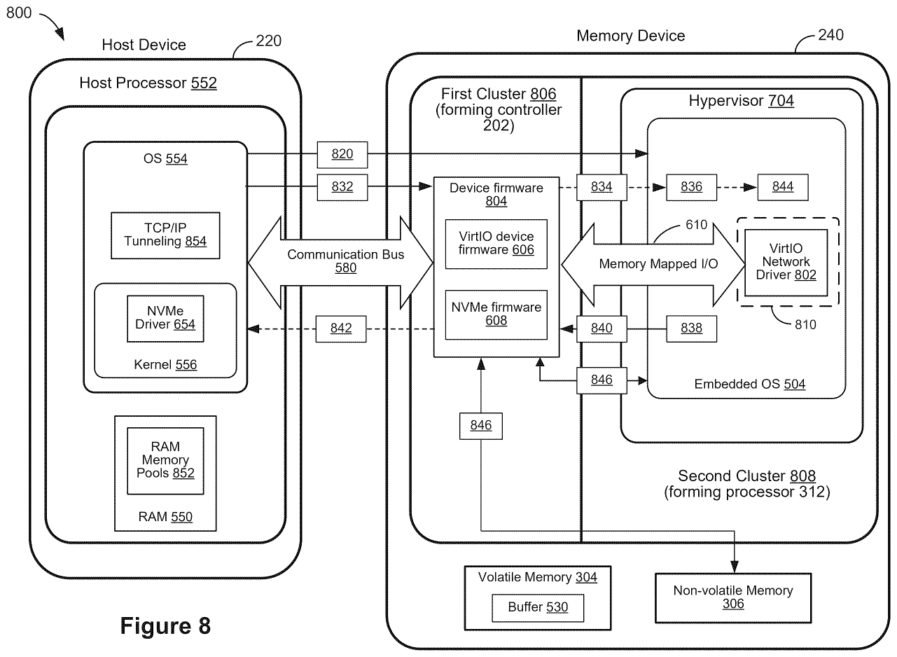

FIG. 8 is a block diagram of an example electronic system 800 in which a host device 220 and a memory device 240 communicate with each other via TCP/IP network tunneling, in accordance with some embodiments. The memory device 240 is transformed to a computational storage device, and is coupled to the host device 220 via a communication bus 580. The memory device 240 includes at least a data processor 312, a memory controller 202, a volatile memory 304 including a memory buffer 530, and a non-volatile memory 306. In some embodiments, the memory device 240 further includes an input/output data interface 540 (FIG. 6) for driving the communication bus 580 between the host device 220 and the memory device 240 based on a data communication protocol (e.g., PCIe). In some embodiments, the communication bus 580 includes a PCIe link. In some embodiments, the non-volatile memory 306 of the memory device 240 includes one or more NAND flash chips. The memory controller 202 is configured to access and manage data stored in the one or more NAND flash chips, and the data processor 312 is configured to obtain and process the data stored in the one or more NAND flash chips.

In some embodiments, the memory device 240 includes a system on chip (SOC) having a plurality of processors. The plurality of processors of the SOC include a first cluster 806 of one or more processors for providing the memory controller 202 and a second cluster 808 of one or more processors for providing the data processor 240. Each of the second cluster 808 of one or more processors distinct form the first cluster 806 of one or more processors. In some embodiments, the SOC provides greater performance (e.g., in terms of integration, energy efficiency, robustness, thermal management) for the memory device 204 and further allows to combine different types of cores (e.g., high-performance cores, power-efficient cores, CPU, GPU) to balance performance, efficiency, package volume, and other factors.

In some embodiments, the host device 220 includes at least a host processor 552 and a random access memory (RAM) 550 having RAM memory pools 852. The host processor 552 is configured to execute a host operating system 554 (e.g., Linux) having a host kernel 556. In some embodiments, the host kernel 656 includes one or more data drivers having an NVMe driver 654. The NVMe driver 654 of the host kernel 656 is configured to communicate data (e.g., data packets) with the memory device 240 based on an NVMe interface standard. In some embodiments, the host operating system 554 is configured to drive a TCP/IP tunneling application 854. The TCP/IP tunneling application 854 is designed to relay data packets for data communication between the host device 220 and the memory device 220 via the communication bus 580. For example, the TCP/IP tunneling application 854 receives data from the host operating system 554 and converts the data to an outgoing message including TCP/IP packets data communication via the NVMe driver 654 and the communication bus 580.

In some embodiments, the memory controller 202 (e.g., the first cluster 806) includes a device firmware 804. In some embodiments, the device firmware 804 includes a physical device firmware (e.g., an NVMe firmware 608) based on a data transfer protocol (e.g., NVMe) and a virtual network device firmware (e.g., a VirtIO device firmware 606) based on a device protocol (e.g., VirtIO). In some embodiments, the memory device 240 receives data from the host device 220 via the device firmware 804. In some embodiments, incoming data 832 are received via the virtual network device firmware (e.g., the VirtIO device firmware 606). In some embodiments, the data processor 312 communicates first data 846 to be read from, or written to, the non-volatile memory 306 of the memory device 240 via the device firmware 804 (e.g., the NVMe firmware 608) based on the data transfer protocol (e.g., NVMe). The first data 846 includes data packets for data communication between the host device 220 and the memory device 240. In some embodiments, the NVMe firmware 608 is a computational module responsible for traditional NVMe storage functionality. The NVMe firmware 608 controls the memory controller 202, the input/output data interface 540 (FIGS. 5 and 6), and the communication bus 580. In some embodiments, the NVMe firmware 608 shares the communication bus 580 with the embedded operating system 504.

In some embodiments, the second cluster 808 (e.g., the data processor 312) of the electronic system 800 is configured to execute an embedded operating system 504 (e.g., Linux) having a VirtIO network driver 802 (e.g., VirtIO network device driver 714 in FIG. 7). The VirtIO network driver 802 is part of a standard Linux kernel. In some embodiments, the electronic system 800 creates a network tunnel between the embedded operating system 504 and the host operating system 554 without providing additional custom network driver(s) to the embedded operating system 504. In some embodiments, the second cluster 808 (e.g., the data processor 312) of the electronic system 800 is configured to execute a hypervisor 704, which monitors the embedded operating system 504. In some embodiments, data communication between the VirtIO network driver 802 and the device firmware 804 is routed via an MMIO transport 610. The MMIO transport 610 is a memory address mapping mechanism configured to manage data communication between the embedded operating system 504 and the communication bus 580.

In some embodiments, the memory device 240 provides a network tunnel for transferring TCP/IP data packets from the host device 220 to the memory device 240. The memory device 240 receives, from the host device 220, incoming data 832 via the communication bus 580. The memory device 240 further extracts an incoming data packet 834 from the incoming data 832 based on a data communication protocol (e.g., PCIe). The incoming data packet 834 complies with a first device protocol (e.g., VirtIO). The memory device 240 further provides the incoming data packet 834 to the data processor 312. The data processor 312 further generates target data 836 that complies with a second device protocol (e.g., TCP/IP) based on the incoming data packet 834. In some embodiments, the target data 836 conforms to structures and standards defined by the TCP/IP communication standard.

In some embodiments, the memory device 240 provides the network tunnel for sending TCP/IP data packets from the memory device 240 to the host device 220. The data processor 312 of the memory device 240 generates first payload data 838 based on the second device protocol (e.g., TCP/IP). Based on the first payload data 838, the data processor 312 generates second payload data 840 that complies with the first device protocol (e.g., VirtIO). The memory device 240 further converts the second payload data 840 to an outgoing data packet 842 based on the data communication protocol (e.g., PCIe). The memory device 240 further communicates the outgoing data packet 842 to the host device 220 via the communication bus 580. In some embodiments, the first payload data 838 is formatted and prepared for transmission over the TCP/IP communication standard.

In some embodiments, the data processor 312 of the memory device 240 generates the second payload data 840 by adding a respective header (e.g., VirtIO Header) associated with the first device protocol (e.g., VirtIO) to the first payload data 838. In some embodiments, a VirtIO header (e.g., Virtio-net header, a Virtio-block header) is a metadata structure added to data packets or requests in VirtIO-based devices. The VirtIO header provides necessary information for processing and routing data between a virtual machine (e.g., the virtual machine/guest operating system 702) and a hypervisor (e.g., hypervisor 704). The header structure varies depending on types of VirtIO devices (e.g., network devices, block devices).

In some embodiments, the data processor 312 of the memory device 240 generates the target data 836 by removing a respective header (e.g., VirtIO Header) associated with the first device protocol (e.g., VirtIO) from the incoming data packet 834. In some embodiments, a Virtio header is removed for the data processor 312 to interpret or forward data packets without Virtio-specific metadata.

In some embodiments, the memory device 240 processes, at the data processor 312, the target data 836 based on the second device protocol (e.g., TCP/IP) to generate user data 844 (e.g., by removing a respective TCP/IP header from the target data 836). The memory device 240 further processes, at the data processor 312, the user data 844. In some embodiments, the user data 844 includes information content being communicated between the host device 220 and the memory device 240. In some embodiments, the user data 844 are separated from protocol headers, control information, and metadata.

In some embodiments, the memory device 240 obtains an operating system image 820 (e.g., a standard Linux image) from the host device 220. The memory device 240 further executes the embedded operating system 504 on the data processor 312 based on the operating system image 820. In some embodiments, the memory device 240 loads the embedded operating system 504 based on the operating system image 820 and aborts installation of custom software or driver(s). In some embodiments, the operating system image 820 is packaged into a single file or set of files. The operating system image 820 includes components applied to boot and run the embedded operating system 504. In some embodiments, the data processor 312 provides a functionality to execute the operating system image 820 having a VirtIO network driver (e.g., VirtIO network device driver 714 in FIG. 7).

In some embodiments, the data processor 312 of the memory device 240 is configured to execute the embedded operating system 504. The embedded operating system 504 complies with a standard Linux kernel. The data processor 312 provides a virtualized interface 810 for the embedded operating system 504. The virtualized interface 810 is configured to expose the memory device 240 as a virtual data processing device (e.g., a virtualized network card, a virtual network device) including the data processor 312 to the host device 220. In some embodiments, the virtualized interface 810 is configured to expose the data processor 312 for in-memory data processing. In some embodiments, the virtualized interface 810 includes a virtual network device port (e.g., the virtual network device port 612 in FIG. 6). In some embodiments, the hypervisor 704 provides, through the data processor 312, the virtualized interface 810 for the embedded operating system 504.

In some embodiments, the memory device 240 enumerates the virtual data processing device to the communication bus 580 through the virtualized interface 810. The memory device 240 further generates, based on the MMIO transport 610, an address mapping to connect the virtual data processing device to the communication bus 580. The memory device 240 further transfers the target data 836 from the communication bus 580 to the data processor 312 in accordance with the address mapping. In some embodiments, the memory device 240 further sends outgoing payload data (e.g., the first payload data 838, the second payload data 840) from the data processor 312 to the communication bus 580 in accordance with the address mapping.

In some embodiments, the memory device 240 includes one or more processors. The memory device 240 provides a time allocation configuration (e.g., priority scheduling, multilevel queue scheduling) to allocate resources of the one or more processors for different functions (e.g., storage functions and computation functions). The memory device 240 allocates a first time slot of the one or more processors to the memory controller 202. The memory device 240 further allocates a second time slot of the one or more processors to the data processor 312. The second time slot is distinct from the first time slot. In some embodiments, the time allocation configuration allows to schedule and manage time slices for processes or threads within the memory device 240. In some embodiments, the time allocation configuration allows for multitasking to ensure that all tasks related to the memory controller 202 or the data processor 312 obtain necessary processing time, thereby achieving high-performance computing and high-efficiency usage of resources.

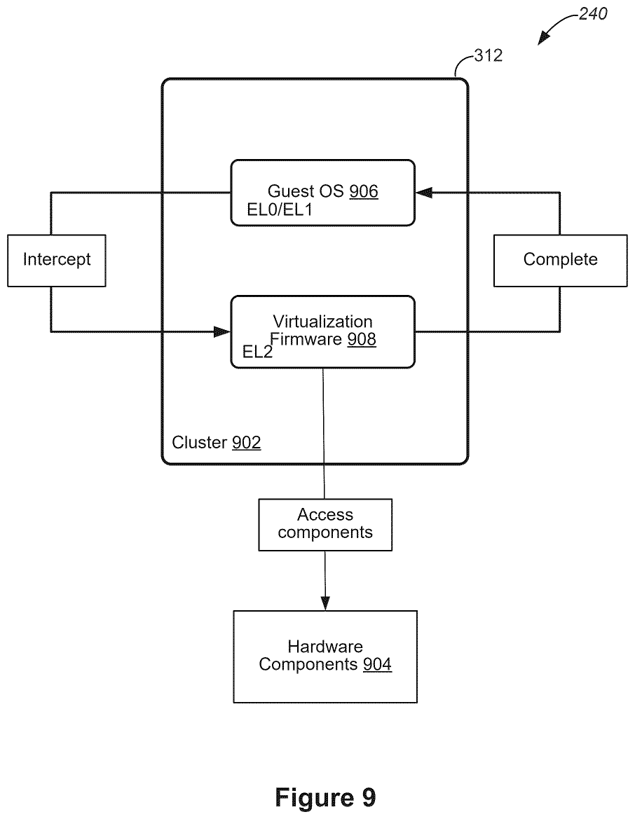

FIG. 9 is a block diagram of an example memory device 240 that features a virtualization architecture, in accordance with some embodiments. The memory device 240 includes at least a plurality of processors and hardware components 904. The plurality of processors include a cluster 902 that forms a data processor 312. In some embodiments, the hardware components 904 include at least a memory controller 202 having a firmware (e.g., the NVMe firmware 608), a volatile memory 304 having a memory buffer 530, and a non-volatile memory 306.

In some embodiments, the data processor 312 includes a guest operating system 906 (e.g., the virtual machine/guest operating system 702) and a virtualization firmware 908. In some embodiments, the guest operating system 906 is a virtual machine created by a hypervisor (e.g., the hypervisor 704 in FIGS. 7 and 8), which is used to manage the machine associated with the embedded operating system 504. In some embodiments, the virtualization firmware 908 is in compliance with the VirtIO interface standard and is configured to drive the hypervisor. In some embodiments, the virtualization firmware 908 includes a virtual network device firmware (e.g., the VirtIO device firmware 606 in FIGS. 6 and 8).

In some embodiments, the guest operating system 906 is executed by the data processor 312 with an exception level 0 (e.g., “EL0”) and/or an exception level 1 (e.g., “EL1”). The virtualization firmware 908 is implemented at an exception level 2 (e.g., “EL2”) of the data processor 312. A plurality of exception levels define various privilege levels at which code can execute for data managing, resource accessing, exception handling, and more. The exception levels dictate the scope of control of code over components (e.g., the embedded operating system 504, the hypervisor 704.). Lower exception levels have higher privileges. For example, EL0 is applied for a user mode, which is the lowest privilege level designed for user applications. EL1 is applied for a kernel or operating system mode. EL2 is applied to a hypervisor mode, which is used to manage virtual machines.

In some embodiments, when the guest operating system 906 (e.g., the virtual machine) attempts to interact with the hardware components 904 of the memory device 240, the virtualization firmware 908 intercepts execution of the guest operating system 906 and enumerates a virtual data processing device (e.g., the exposed memory device 240) for accessing the hardware components 904. In some embodiments, when emulation of the virtual data processing device is complete, the virtualization firmware 908 stops the interception and the guest operating system 906 continues the corresponding execution. In some embodiments, the virtualization firmware 908 has privileges over the guest operating system 906 to access the hardware components 904 of the memory device 240.

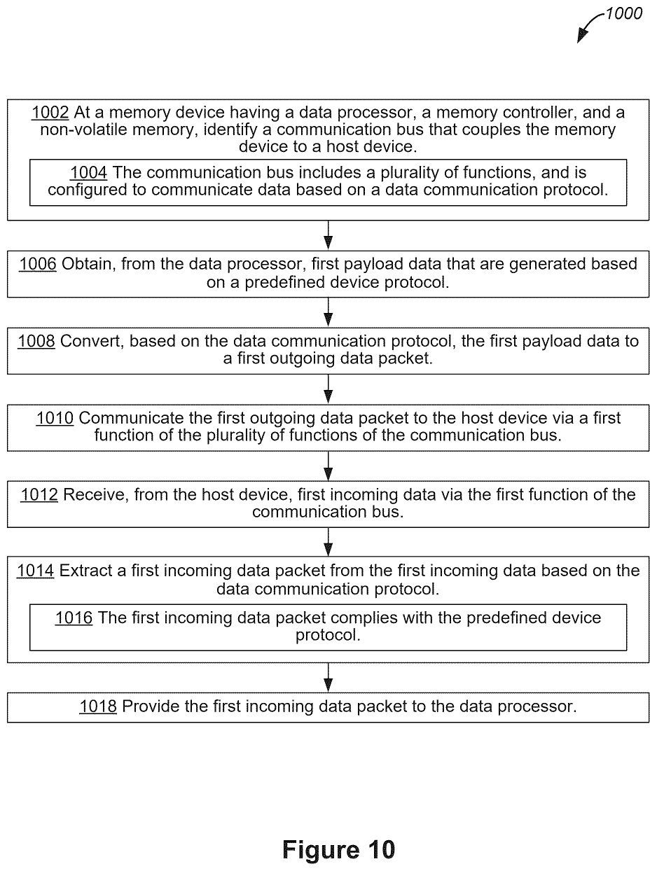

FIG. 10 is a flow diagram of an example method 1000 for data communication at a memory device 240, in accordance with some embodiments. Specifically, the flow diagram of FIG. 10 is implemented at the memory device 240 that includes a computational storage device described above in reference to FIGS. 1-9. The method 1000 includes at the memory device 240 having a data processor 312, a memory controller 202, and a non-volatile memory 306, identifying (operation 1002) a communication bus 580 that couples the memory device 240 to a host device 220. The communication bus 580 includes (operation 1004) a plurality of functions, and is configured to communicate data based on a data communication protocol. The method 1000 further includes obtaining (operation 1006), from the data processor 312, first payload data 632 that are generated based on a predefined device protocol. The method 1000 further includes converting (operation 1008), based on the data communication protocol, the first payload data 632 to a first outgoing data packet 634. The method 1000 further includes communicating (operation 1010) the first outgoing data packet 634 to the host device 220 via a first function 602 of the plurality of functions of the communication bus 580.

In some embodiments, the method 1000 further includes receiving (operation 1012), from the host device 220, first incoming data 636 via the first function 602 of the communication bus 580. The method 1000 further includes extracting (operation 1014) a first incoming data packet 638 from the first incoming data 636 based on the data communication protocol. The first incoming data packet 638 complies (operation 1016) with the predefined device protocol. The method 1000 further includes providing (operation 1018) the first incoming data packet 638 to the data processor 312.

In some embodiments, the method 1000 further includes obtaining, from the memory controller 202, second payload data that are generated based on a data transfer protocol. The method 1000 further includes converting, based on the data communication protocol, the second payload data to a second outgoing data packet. The method 1000 further includes communicating the second outgoing data packet to the host device 220 via a second function of the plurality of functions of the communication bus 580.

In some embodiments, the data transfer protocol includes an NVMe interface standard.

In some embodiments, the method 1000 further includes receiving, from the host device, second incoming data 646 via a second function 604 of the plurality of functions of the communication bus 580. The method 1000 further includes extracting a second incoming data packet 648 from the second incoming data 646 based on the data communication protocol. The second incoming data packet 648 complies with a data transfer protocol. The method 1000 further includes providing the second incoming data packet 648 to the memory controller 202.

In some embodiments, the method 1000 further includes providing a plurality of device interfaces, each device interface corresponding to a respective distinct function of the plurality of functions and a respective protocol.

In some embodiments, providing the plurality of device interfaces further includes providing a first device interface 622 based on the first function 602 of the plurality of functions of the communication bus 580 and the predefined device protocol. The first device interface 622 is configured to expose the memory device 240 as a virtual data processing device including the data processor 312 to the host device 220.

In some embodiments, providing the plurality of device interfaces further includes providing a second device interface 624 based on a second function 604 of the plurality of functions of the communication bus 580 and a data transfer protocol. The second device interface is configured to expose the memory device 240 as a storage device including the memory controller 202 to the host device 220.

In some embodiments, the method 1000 further includes implementing at least two of the plurality of device interfaces on the communication bus 580 according to a time-splitting scheme.

In some embodiments, the method 1000 further includes implementing at least two of the plurality of device interfaces on the communication bus 580 concurrently using distinct physical bandwidths of the communication bus 580.

In some embodiments, the data communication protocol includes a Peripheral Component Interconnect Express (PCIe) interconnect standard.

In some embodiments, the predefined device protocol includes a Virtual I/O Device (VirtIO) interface standard.

In some embodiments, the non-volatile memory 306 includes one or more NAND flash chips, and the memory controller 202 is configured to access and manage data stored in the one or more NAND flash chips. The data processor 312 is configured to process the data stored in the one or more NAND flash chips.

In some embodiments, the method 1000 further includes at the data processor 312, executing an embedded operating system 504. The embedded operating system 504 is unmodified to support the predefined device protocol.

In some embodiments, the embedded operating system 504 includes a virtual network driver (e.g., 710 to 720) that is configured to operate in compliance with the predefined device protocol. The method 1000 further includes providing, at the virtual network driver (e.g., 710 to 720), a virtual network device port 612 for the embedded operating system 504.

In some embodiments, the virtual network driver (e.g., 710 to 720) is configured to support at least one of a plurality of input/output devices including a block device, a consoled device, and a network device.

In some embodiments, the method 1000 further includes at the memory controller 202, providing a virtual device firmware (e.g., 606) to communicate the first outgoing data packet 634. The method 1000 further includes enumerating the virtual network device port 612 to the communication bus 580 through the virtual device firmware (e.g., 606).

In some embodiments, the method 1000 further includes providing, based on the embedded operating system 504, a paravirtualized interface in compliance with the predefined device protocol. The method 1000 further includes routing, through the paravirtualized interface, a plurality of data packets between the memory device 240 and the host device 220.

In accordance with some embodiments, a non-transitory computer readable storage medium stores one or more programs. The one or more programs include instructions that, when executed by a memory device 240 that includes a data processor 312, a memory controller 202, and a non-volatile memory 306, cause the memory device 240 to perform any of the methods described in the above embodiments.

In accordance with some embodiments, a memory device 240 includes a data processor 312, a memory controller 202, and a non-volatile memory 306. The memory device 240 stores one or more programs including instructions to perform any of the methods described in the above embodiments.

In accordance with some embodiments, an electronic system includes a host device 220 and a memory device 240 coupled to the host device. The memory device 240 further includes a data processor 312, a memory controller 202, and a non-volatile memory 306. The memory device 240 stores one or more programs including instructions to perform any of the methods described in the above embodiments.

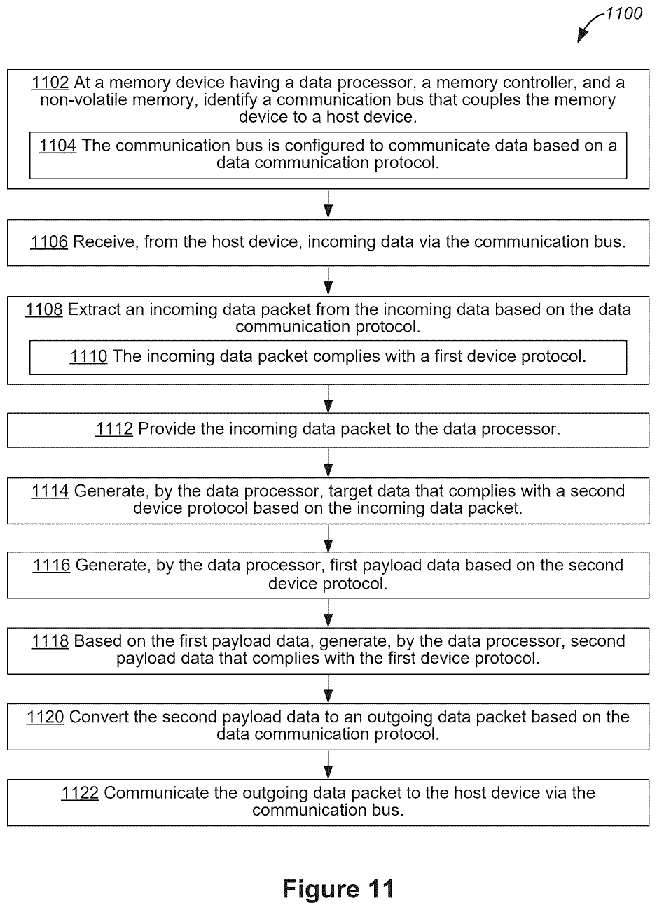

FIG. 11 is a flow diagram of an example method 1100 for data communication at a memory device 240, in accordance with some embodiments. Specifically, the flow diagram of FIG. 11 is implemented at the memory device 240 that includes a computational storage device described above in reference to FIGS. 1-9. The method 1100 includes at the memory device 240 having a data processor 312, a memory controller 202, and a non-volatile memory 306 identifying (operation 1102) a communication bus 580 that couples the memory device 240 to a host device 220. The communication bus 580 is configured to communicate (operation 1104) data based on a data communication protocol. The method 1100 further includes receiving (operation 1106), from the host device 220, incoming data 832 via the communication bus 580. The method 1100 further includes extracting (operation 1108) an incoming data packet 834 from the incoming data 832 based on the data communication protocol. The incoming data packet 834 complies (operation 1110) with a first device protocol. The method 1100 further includes providing (operation 1112) the incoming data packet 834 to the data processor 312. The method 1100 further includes generating (operation 1114), by the data processor 312, target data 836 that complies with a second device protocol based on the incoming data packet 834.

In some embodiments, the method 1100 further includes generating (operation 1116), by the data processor 312, first payload data 838 based on the second device protocol. The method 1100 further includes based on the first payload data 838, generating (operation 1118), by the data processor 312, second payload data 840 that complies with the first device protocol. The method 1100 further includes converting (operation 1120) the second payload data 840 to an outgoing data packet 842 based on the data communication protocol. The method 1100 further includes (operation 1122) communicating the outgoing data packet 842 to the host device 220 via the communication bus 580.

In some embodiments, generating the second payload data 840 further includes adding a respective header associated with the first device protocol to the first payload data 838.

In some embodiments, generating the target data 836 further includes removing a respective header associated with the first device protocol from the incoming data packet 834.

In some embodiments, the method 1100 further includes at the data processor 312, processing the target data 836 based on the second device protocol to generate user data 844. The method 1100 further includes processing the user data 844.

In some embodiments, the method 1100 further includes obtaining an operating system image. The method 1100 further includes executing an embedded operating system 504 on the data processor 312 based on the operating system image.

In some embodiments, the data processor 312 is configured to execute the embedded operating system 504, and the embedded operating system 504 complies with a standard Linux kernel (e.g., 506). The method 1100 further includes providing, at the data processor 312, a virtualized interface 810 for the embedded operating system 504 configured to expose the memory device 240 as a virtual data processing device including the data processor 312 to the host device 220.

In some embodiments, the method 1100 further includes enumerating the virtual data processing device to the communication bus 580 through the virtualized interface 810. The method 1100 further includes generating, based on memory mapped I/O (MMIO) transport 610, an address mapping to connect the virtual data processing device to the communication bus 580. The method 1100 further includes transferring the target data 836 from the communication bus 580 to the data processor 312 in accordance with the address mapping.

In some embodiments, the method 1100 further includes enumerating the virtual data processing device to the communication bus 580 through the virtualized interface 810. The method 1100 further includes generating, based on memory mapped I/O (MMIO) transport 610, an address mapping to connect the virtual data processing device to the communication bus 580. The method 1100 further includes sending outgoing payload data (e.g., 838, 840) from the data processor 312 to the communication bus 580 in accordance with the address mapping.

In some embodiments, the memory device 240 includes a system on chip (SOC) having a plurality of processors. The plurality of processors include a first cluster 806 of one or more processors for providing the memory controller 202 and a second cluster 808 of one or more processors for providing the data processor 312. Each of the second cluster 808 of one or more processors is distinct form the first cluster 806 of one or more processors.

In some embodiments, the memory device 240 includes one or more processors. The method 1100 further includes allocating a first time slot of the one or more processors to the memory controller 202. The method 1100 further includes allocating a second time slot of the one or more processors to the data processor 312, wherein the second time slot is distinct from the first time slot.

In some embodiments, the non-volatile memory 306 includes one or more NAND flash chips, and the memory controller 202 is configured to access and manage data stored in the one or more NAND flash chips. The data processor 312 is configured to process the data stored in the one or more NAND flash chips.

In some embodiments, the data communication protocol includes a Peripheral Component Interconnect Express (PCIe) interconnect standard.

In some embodiments, the first device protocol includes a Virtual I/O Device (VirtIO) interface standard.

In some embodiments, the second device protocol includes a Transmission Control Protocol/Internet Protocol (TCP/IP) communication standard.

In some embodiments, the method 1100 further includes providing a device firmware including a physical device firmware (e.g., 608) based on a data transfer protocol and a virtual network device firmware (e.g., 606) based on the first device protocol. The incoming data 832 is received via the virtual network device firmware (e.g., 606).

In some embodiments, the method 1100 further includes communicating first data 846 to be read from, or written to, the non-volatile memory 306 via the physical device firmware (e.g., 608) based on the data transfer protocol.

In some embodiments, the data transfer protocol corresponds to an NVMe interface standard.

In accordance with some embodiments, a non-transitory computer readable storage medium stores one or more programs. The one or more programs include instructions that, when executed by a memory device 240 that includes a data processor 312, a memory controller 202, and a non-volatile memory, cause the memory device 240 to perform any of the methods described in the above embodiments.

In accordance with some embodiments, a memory device 240 includes a data processor 312, a memory controller 202, and a non-volatile memory. The memory device 240 stores one or more programs including instructions to perform any of the methods described in the above embodiments.

In accordance with some embodiments, an electronic system includes a host device 220 and a memory device 240 coupled to the host device 220. The memory device 240 further includes a data processor 312, a memory controller 202, and a non-volatile memory 306. The memory device 240 stores one or more programs including instructions to perform any of the methods described in the above embodiments.

It should be understood that the particular order in which the operations in FIGS. 10 and 11 have been described are merely exemplary and are not intended to indicate that the described order is the only order in which the operations could be performed. One of ordinary skill in the art would recognize various ways to providing computational storage devices as described herein. It is also noted that more details on the method of providing computational storage devices are explained above with reference to FIGS. 1-9. For brevity, these details are not repeated in the description herein.

Memory is also used to store instructions and data associated with the methods 1000 and 1100, and includes high-speed random-access memory, such as SRAM, DDR DRAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory, optionally, includes one or more storage devices remotely located from one or more processing units. Memory, or alternatively the non-volatile memory within memory, includes a non-transitory computer readable storage medium. In some embodiments, memory, or the non-transitory computer readable storage medium of memory, stores the programs, modules, and data structures, or a subset or superset for implementing the methods 1000 and 1100. Alternatively, in some embodiments, the memory device implements the methods 1000 and 1100 at least partially based on an ASIC. The memory device includes a computational storage device (e.g., an SSD configured with data processing capabilities) in a data center or a client device.

In some embodiments, data are processed in one or more processors of a host device (e.g., a computer, a server), while a memory device is applied to provide input data or store output data for the host device. Data communication between the host device and the memory device is based on a Peripheral Component Interconnect Express (PCIe) interface standard. Conversely, in some embodiments, the memory device is transformed to a computational storage device incorporating at least one computing element (e.g., the data processor). The computing element is configured to process internal computational workloads (e.g., data processing operations) locally on the memory device, while a memory controller of the memory device specializes in performing memory access functions and internal memory management functions. In some embodiments, computing elements of a memory device or a plurality of memory devices of a memory system process data with a coherent and uniform perspective of file systems, and follow a substantially consistent programming model. A common file system may be applied based on a network communication network, which operates with a TCP/IP or UDP link. In some embodiments, when it comes to an SSD based memory device, an SSD standard interface is used by the memory device to exchange data with a host device. The memory device includes one or more computing elements that are either embedded in, or coupled to, a memory controller. The one or more computing elements are indirectly coupled the host device via a memory controller and an SSD data interface (e.g., a PCIe data interface) of the memory device.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages be implemented in hardware, firmware, software or any combination thereof.

What is claimed is:

1. A method for data communication, comprising:
at a memory device having a data processor, a memory controller, and a non-volatile memory:
identifying a communication bus that couples the memory device to a host device, wherein the communication bus includes a plurality of functions, and is configured to communicate data based on a data communication protocol;
obtaining, from the data processor, first payload data that are generated based on a predefined device protocol;
converting, based on the data communication protocol, the first payload data to a first outgoing data packet; and
communicating the first outgoing data packet to the host device via a first function of the plurality of functions of the communication bus.

2. The method of claim 1, further comprising:
receiving, from the host device, first incoming data via the first function of the communication bus;
extracting a first incoming data packet from the first incoming data based on the data communication protocol, wherein the first incoming data packet complies with the predefined device protocol; and
providing the first incoming data packet to the data processor.

3. The method of claim 1, further comprising:
obtaining, from the memory controller, second payload data that are generated based on a data transfer protocol;
converting, based on the data communication protocol, the second payload data to a second outgoing data packet; and
communicating the second outgoing data packet to the host device via a second function of the plurality of functions of the communication bus.

4. The method of claim 3, wherein the data transfer protocol includes a Nonvolatile Memory Express (NVMe) interface standard.

5. The method of claim 1, further comprising:
receiving, from the host device, second incoming data via a second function of the plurality of functions of the communication bus;
extracting a second incoming data packet from the second incoming data based on the data communication protocol, wherein the second incoming data packet complies with a data transfer protocol; and
providing the second incoming data packet to the memory controller.

6. The method of claim 1, further comprising:
providing a plurality of device interfaces, each device interface corresponding to a respective distinct function of the plurality of functions and a respective protocol.

7. The method of claim 6, wherein providing the plurality of device interfaces further comprising:
providing a first device interface based on the first function of the plurality of functions of the communication bus and the predefined device protocol, wherein the first device interface is configured to expose the memory device as a virtual data processing device including the data processor to the host device.

8. The method of claim 6, wherein providing the plurality of device interfaces further comprising:
providing a second device interface based on a second function of the plurality of functions of the communication bus and a data transfer protocol, wherein the second device interface is configured to expose the memory device as a storage device including the memory controller to the host device.

9. The method of claim 6, further comprising:
implementing at least two of the plurality of device interfaces on the communication bus according to a time-splitting scheme.

10. The method of claim 6, further comprising:
implementing at least two of the plurality of device interfaces concurrently on the communication bus using distinct physical bandwidths of the communication bus.

11. A memory device, comprising:
a data processor;
a memory controller; and
a non-volatile memory;
wherein the memory device stores one or more programs comprising instructions for:
identifying a communication bus that couples the memory device to a host device, wherein the communication bus includes a plurality of functions, and is configured to communicate data based on a data communication protocol;
obtaining, from the data processor, first payload data that are generated based on a predefined device protocol;
converting, based on the data communication protocol, the first payload data to a first outgoing data packet; and
communicating the first outgoing data packet to the host device via a first function of the plurality of functions of the communication bus.

12. The memory device of claim 11, wherein the data communication protocol includes a Peripheral Component Interconnect Express (PCIe) interconnect standard.

13. The memory device of claim 11, wherein the predefined device protocol includes a Virtual I/O Device (VirtIO) interface standard.

14. The memory device of claim 11, wherein the non-volatile memory includes one or more NAND flash chips, and the memory controller is configured to access and manage data stored in the one or more NAND flash chips, and wherein the data processor is configured to process the data stored in the one or more NAND flash chips.

15. A non-transitory computer readable storage medium storing one or more programs, the one or more programs comprising instructions that, when executed by a memory device that includes a data processor, a memory controller, and a non-volatile memory, cause the memory device to perform:
identifying a communication bus that couples the memory device to a host device, wherein the communication bus includes a plurality of functions, and is configured to communicate data based on a data communication protocol;
obtaining, from the data processor, first payload data that are generated based on a predefined device protocol;
converting, based on the data communication protocol, the first payload data to a first outgoing data packet; and
communicating the first outgoing data packet to the host device via a first function of the plurality of functions of the communication bus.

16. The non-transitory computer readable storage medium of claim 15, the one or more programs further comprising instructions for, at the data processor, executing an embedded operating system, wherein the embedded operating system is unmodified to support the predefined device protocol.

17. The non-transitory computer readable storage medium of claim 16, wherein the embedded operating system includes a virtual network driver that is configured to operate in compliance with the predefined device protocol, the one or more programs further comprising instructions for:
providing, at the virtual network driver, a virtual network device port for the embedded operating system.

18. The non-transitory computer readable storage medium of claim 17, wherein the virtual network driver is configured to support at least one of a plurality of input/output devices including a block device, a consoled device, and a network device.

19. The non-transitory computer readable storage medium of claim 17, the one or more programs further comprising instructions for:
at the memory controller, providing a virtual device firmware to communicate the first outgoing data packet; and
enumerating the virtual network device port to the communication bus through the virtual device firmware.

20. The non-transitory computer readable storage medium of claim 16, further comprising:
providing, based on the embedded operating system, a paravirtualized interface in compliance with the predefined device protocol; and
routing, through the paravirtualized interface, a plurality of data packets between the memory device and the host device.
